(19) United States
(12) Patent Application Publication
(10) Pub. No.: US 2017/0193765 A1
(43) Pub. Date: Jul. 6, 2017

(54) BARRIER PROTECTION AND LIGHTING SYSTEM

(71) Applicant: Senstar Corporation, Carp (CA)

(72) Inventor: Jeremy Weese, Carp (CA)

(21) Appl. No.: 15/386,742

(22) Filed: Dec. 21, 2016

Related U.S. Application Data
(60) Provisional application No. 62/274,606, filed on Jan. 4, 2016.

(51) Int. Cl. G08B 5/36; H04B 17/318; G08B 21/18; G08B 13/24

(52) U.S. Cl. CPC G08B 5/36; G08B 13/2494; H04B 17/318; G08B 21/182

(57) ABSTRACT

There is provided a lighting device consisting of two or more light emitting diodes (LEDs) which are configured to provide an elliptical pattern of light to illuminate a barrier and/or adjacent areas. The lighting device may be part of a barrier protection apparatus and system. The apparatus includes the lighting device, a processing device, a wireless communications subsystem, and one or more sensors configured to detect a possible intrusion of the barrier. Each apparatus may also communicate wirelessly with neighbouring apparatuses and/or a central controller. The data from one or more sensors may be received and analyzed by each apparatus and/or by the central controller to determine whether an alarm condition has occurred indicating a possible intrusion. Each apparatus and/or the central controller is configured to control the lighting device based on the received sensor data.

### TECHNICAL FIELD

The present application relates to a lighting and sensor system for barrier protection and security.

### BACKGROUND

Lighting has been used in perimeter security systems as both a visual deterrent to an intruder and an aide to image capture as part of the detect, light-up, and assess protection sequence. The use of different light technologies such as light emitting diodes (LEDs), in distributed lighting systems may reduce light pollution and power consumption and may improve the quality of lighting through an improved colour rendition index. An LED generally produces a limited range of illumination and the location of the intrusion may be difficult to quickly identify.

### SUMMARY OF THE INVENTION

According to one embodiment of the present disclosure, there is provided a lighting device consisting of two or more light emitting diodes (LEDs) which are configured to provide an elliptical pattern of light to illuminate a barrier and adjacent areas. The arrangement of the LEDs may minimize the gradient of lighting intensity in the area around the lighting device in order to improve the performance of a closed circuit television system (CCTV). The lighting device may be part of a barrier protection apparatus and system. The apparatus includes said lighting device, a processing device, a wireless communications subsystem, and one or more sensors configured to detect a possible intrusion of the barrier. The one or more sensors may include an accelerometer to detect vibrations of the barrier. The wireless communications subsystem may also operate as a sensor since it may be configured to measure changes in characteristics of received signals indicative of a disruption in the signal path. Each apparatus may also communicate wirelessly with neighbouring apparatuses and a central controller. The data from one or more sensors may be received and analyzed by each apparatus and/or by the central controller to determine whether an alarm condition has occurred indicating a possible intrusion. The apparatus is configured to control the lighting device based on the received sensor data. The central controller also is configured to control the lighting device of one or more apparatuses in the system in response to the received sensor data.

According to another embodiment, there is provided a barrier protection apparatus including a processor, a communications subsystem, and a lighting device having a support structure, and two light emitting diodes (LEDs) mounted to the support structure. The LEDs are configured to provide an elliptical pattern of light to illuminate an area around or near a barrier.

According to another embodiment, there is provided a barrier protection system which includes a central controller, and one or more barrier protection apparatuses spaced apart along a barrier. Each barrier protection apparatus has a processor, a communications subsystem configured to communicate with the central controller, one or more sensors, and a lighting device. The lighting device includes a support structure, and two or more light emitting diodes (LEDs) mounted to the support structure. The LEDs are configured to provide an elliptical pattern of light to illuminate an area around or near a barrier. Methods of operating the apparatuses and system to detect and respond to possible intrusions are also described herein.

### BRIEF DESCRIPTION OF THE DRAWINGS

FIGS. 1A and 1B are top views of a barrier and a barrier protection system according to an embodiment of the present disclosure;

FIGS. 2A and 2B illustrate front and side views of the barrier and barrier protection system according to an embodiment of the present disclosure;

FIGS. 3A-3H are images of example barrier protection apparatuses and lighting devices according to embodiments of the present disclosure;

FIG. 4 is a block diagram of a system according to an embodiment of the present disclosure;

FIG. 5 is a block diagram of a system according to an embodiment of the present disclosure; and

FIG. 6 is a block diagram of a method according to an embodiment of the present disclosure.

Like reference numerals are used in the drawings to denote like elements and features.

While the invention will be described in conjunction with the illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF EXAMPLE IMPLEMENTATIONS

The present disclosure describes a multi-sensor system to protect a barrier by detecting possible intrusions on the barrier or in proximity to the barrier. The barrier may be a wall or a fence or any boundary structure for a house, building, facility, campus, worksite, correctional facility, airport, industrial property, storage facility, or other outdoor or indoor site. It will be appreciated that an intrusion at the barrier may include a person attempting to gain access into a controlled area, or a person attempting to leave or escape a controlled area. An intrusion also may created by an inanimate object being used to compromise a barrier.

The system consists of multiple barrier protection apparatuses distributed along the barrier. Each apparatus supports wireless communications with other apparatuses and with a central monitoring station or controller. Each apparatus consists of a processor, at least one lighting device, a wireless communications subsystem, and one or more sensors. The one or more sensors may include a sensor, such as an accelerometer, which is coupled to the barrier to detect motion or vibration. The wireless communications subsystem supports wireless communications and may also operate as a sensor to detect changes in the environment based on changes in wireless signals. The use of multiple sensors may allow each apparatus in the system to detect intrusions on a variety of barriers such as a chain link fence or a more rigid fence or wall. Changes in the data obtained from the sensors in one or more apparatuses are used to detect a possible intrusion at or near the barrier. When a possible intrusion is detected, the central controller may communicate with one or more apparatuses and control the state of multiple lighting devices near the detected intrusion. In response to the detected intrusion, the lighting device may be turned on or its brightness may be increased. Each lighting device produces a uniform distributed elliptical pattern of light to illuminate an area around or adjacent to the barrier. The distributed light pattern assists with deterring an intruder and also the image capture of the possible intrusion by a surveillance system, such as a closed circuit television system (CCTV).

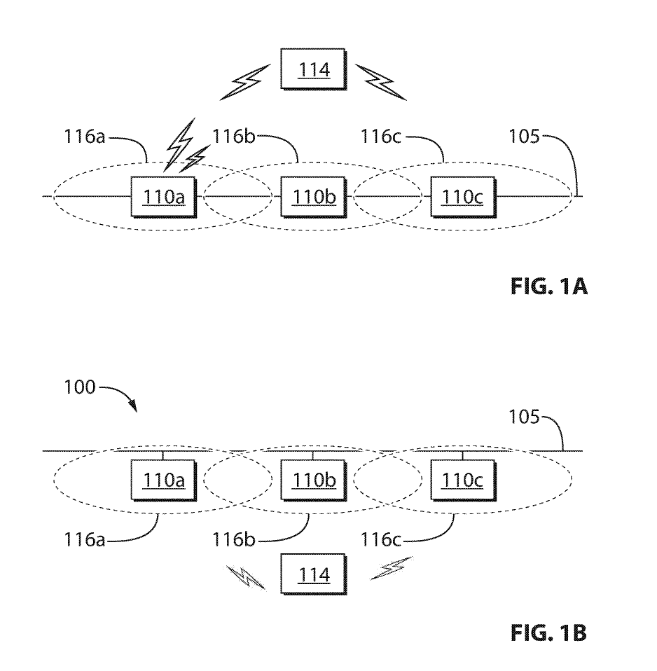

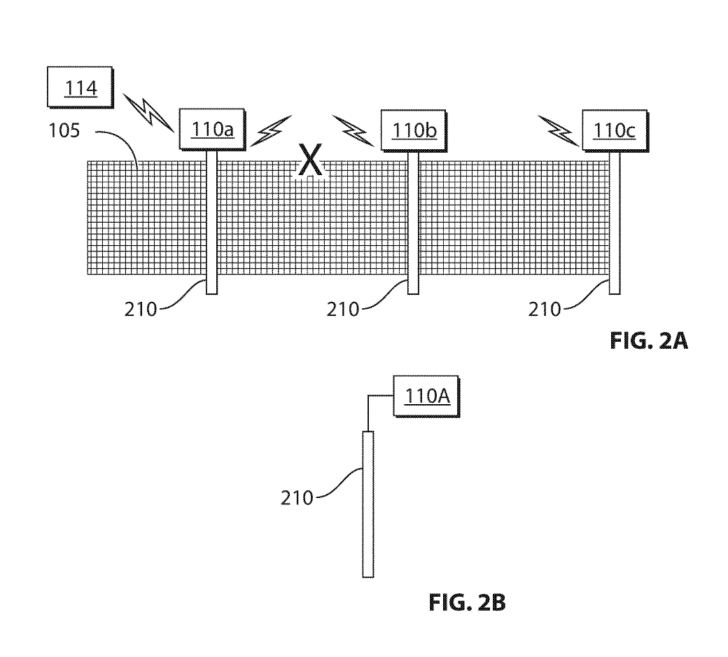

FIGS. 1A and 1B illustrate top views of a barrier protection system 100 for a barrier 105. FIG. 2A illustrates a front view of system 100, the barrier 105 and barrier protection apparatuses 110a, 110b, 110c. FIG. 2B illustrates a side view of the barrier 105 and a barrier protection apparatus 110a of FIG. 1B. The barrier protection system 100 includes a plurality of the barrier protection apparatus 110a, 110b, 110c which are in wireless or wired communication with a central monitoring station or controller 114. In one embodiment as illustrated in FIG. 1A, the barrier protection apparatuses 110a, 110b, 110c are mounted directly above the barrier 105 to illuminate areas around and including the barrier, marked as areas 116a, 116b, 116c. In one embodiment as illustrated in FIG. 1B, each apparatus 110, or at least a portion of each apparatus 110, is offset from the barrier towards a side of interest of the barrier to provide more illumination for that side. For example, if the system 100 is used to detect a possible intrusion (X) on the outside of a wall or a fence of a house or building, the apparatuses 110a, 110b, 110c can be mounted with an offset towards the outside of the wall of the house or building. If the system 100 is used to detect an intruder or escapee at the inside of the wall or fence of a correctional facility, the apparatuses 110a, 110b, 110c can be mounted with an offset towards the inside of the barrier. While many embodiments are described as being mounted to the barrier, it will be appreciated that in some implementations, the apparatuses 110a, 110b, 110c may be mounted to a separate structure adjacent the barrier.

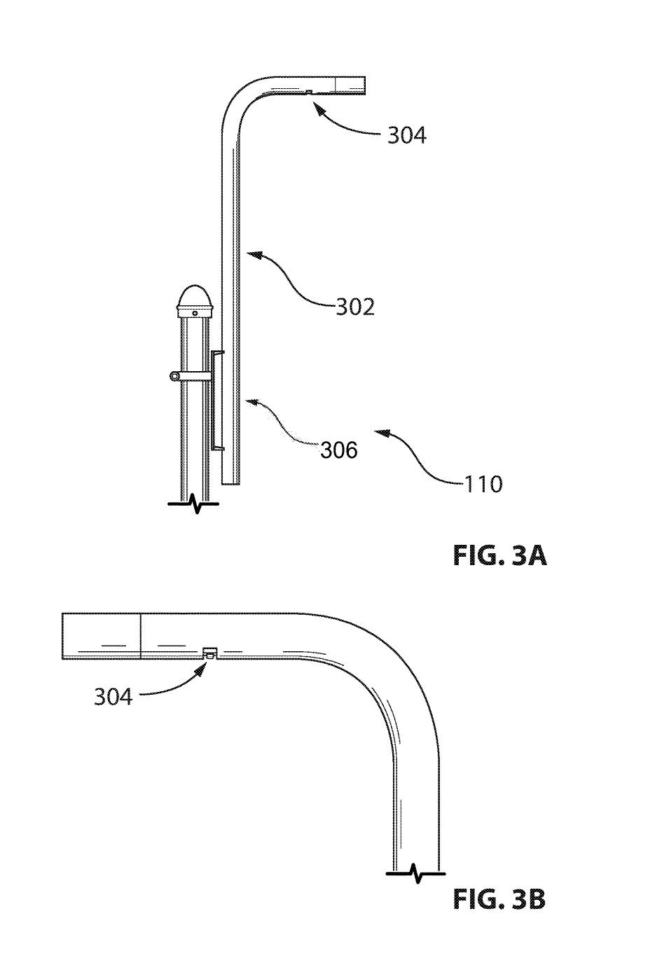

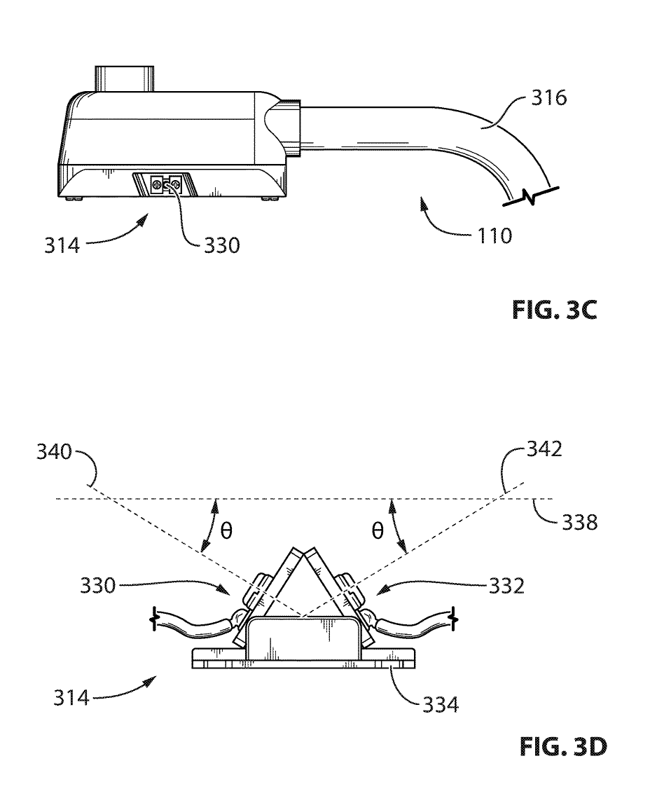

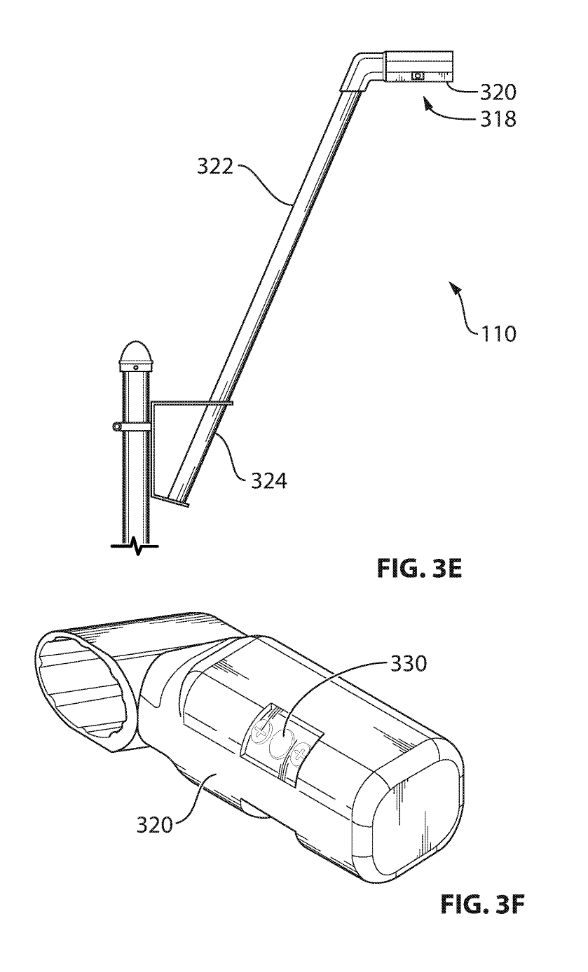

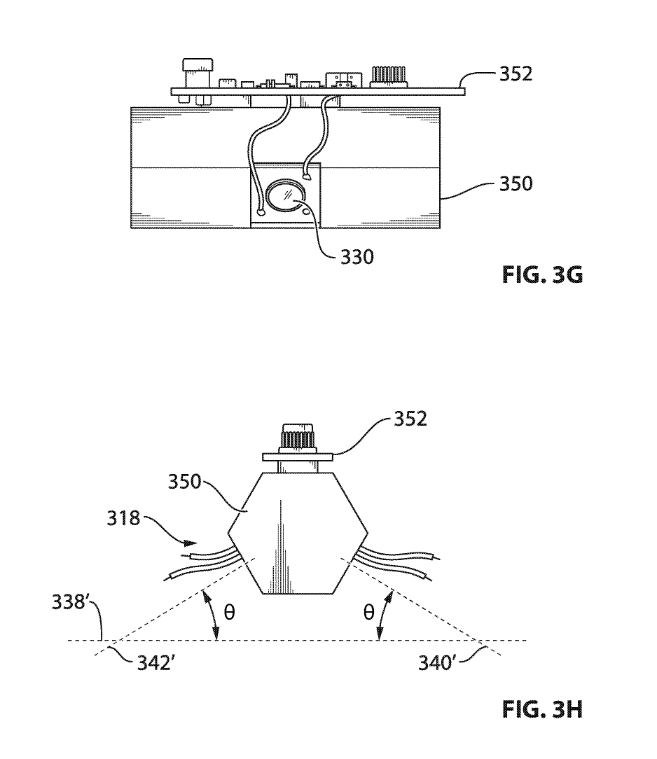

FIGS. 3A-3H illustrate example embodiments of a barrier protection apparatus 110 and lighting devices. The apparatus 110 may consist of a housing 302 which contains a lighting device 304. The housing 302 may be mounted on a barrier 105 in a number of ways. In one example, as illustrated in FIG. 3A, the housing 302 may be a tubular structure which is mounted to a fence post of a chain link fence. As illustrated in FIGS. 3A and 3B, the top portion of the housing contains the lighting device 304 and is configured to cast light downwards and outwards to illuminate the barrier and/or an adjacent area. An alternative embodiment of a lighting device 314 and top portion of a housing 316 are illustrated in FIGS. 3C and 3D. Another embodiment of a lighting device 318 and housing 320 are illustrated in FIGS. 3E and 3F. The housings 302, 316, 320 may be injection moulded and formed, for example, from a XENOY™ polymer in order to better withstand outdoor environments. While the housings 302, 316 are shown with a curved structure to provide an offset of the lighting device 304, 314 from the barrier 105 (as illustrated in FIG. 1B), it will be appreciated that this offset may be achieved through different mechanical configurations and various ways of mounting the apparatus 110 to the barrier 105. In one embodiment, the apparatus 110 may be mounted to the barrier 105 to create the system 100 of FIG. 1A, or the apparatus may be rotated and mounted to the barrier to create the system 100 of FIG. 1B. As shown in the embodiment of FIG. 3E, the housing 320 may include an extension 322 with a base 324 which is mounted at an angle to a post or other structural part of the barrier 105. This mounting configuration moves the lighting device 318 further away from the top of the barrier 105 to extend the reach of the barrier protection apparatus 110. Additional distance between the lighting device 318 and barrier 105 may avoid direct illumination of, and reflections from, the top of the barrier 105. The housings 302, 316, 322 also are configured to contain additional components of the apparatus 110, such as a processor, a wireless communications subsystem, and one or more sensors as described in further detail below.

In one embodiment, each lighting device 304, 314, 318 includes a number of light emitting diodes (LEDs) 330, 332 mounted to a support structure such as a frame 334. Rather than being mounted horizontally within the lighting device 304, 314, 318 with light being directed downwards at an angle of incidence of primarily 90 degrees, each LED may be positioned or directed at an angle to affect the angle of incidence on the barrier and/or on the ground or surface adjacent the barrier. In some embodiments, for a pair of LEDs as illustrated in FIG. 3D, the angle theta (Θ) between the ground, as represented by reference line 338, and a line 340, 342 normal to the plane of each LED 330, 332, is in the range of 20 to 35 degrees. In one embodiment, the pair of LEDs are directed or positioned with angles Θ of approximately 30 degrees. The beam width of each LED is typically between 90 to 135 degrees. Stated differently, in embodiments where the LEDs are mounted symmetrically to the support structure, the lines normal to the plane of each LED may intersect at an angle between 20 to 50 degrees. In other embodiments three or four LEDs may be mounted within the lighting device 304, 314, 318 and configured to produce an elliptical lighting pattern. Any type of LED technology may be used and in some embodiments 120 degree LEDs are provided in the lighting device 304, 314, 318. Each LED thus contributes to a pattern of light extending transversely from the lighting device 304, 314, 318 and along and/or parallel to the barrier. The angled LED arrangement can produce an elliptical lighting pattern having a more uniform intensity by controlling the variables of the beam angles of the LEDs, flux (intensity) of the LEDs, angle of incidence, spacing between the LEDs, and other variables, as described in further detail below. A more uniform distribution is achieved with lower power LEDs and without saturated or high intensity areas below the lighting devices 304, 314, 318. In example embodiments, the two LEDs combine to produce 2 to 3 Watts of light output.

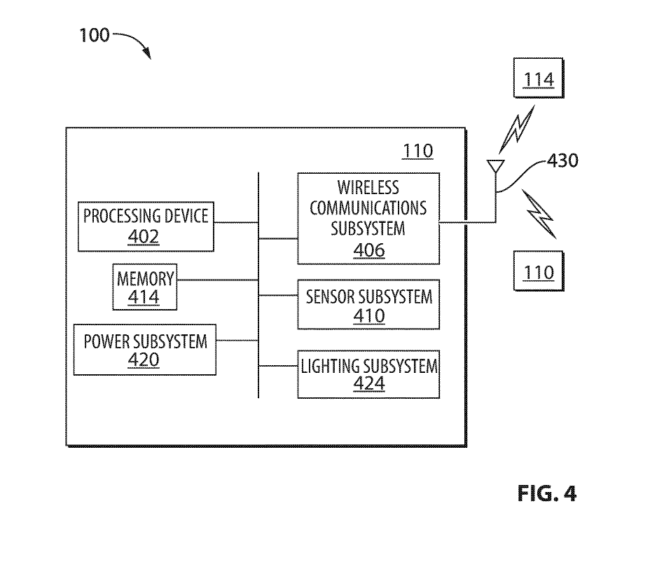

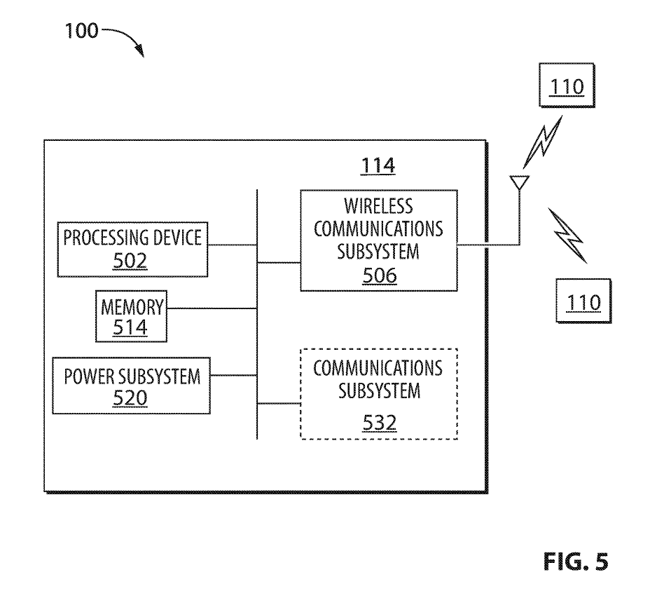

Additional views of the lighting device 318 and components of the apparatus 110 are provided in the side view of FIG. 3G and the front view of FIG. 3H. In this embodiment, the lighting device 318 includes LEDs, such as LED 330, mounted to a support structure such as a heat sink 350. The LED 330 may be mounted or embedded in a channel in the heat sink 350 and connected to a circuit board 352 of the apparatus 110. The circuit board 352 may also be mounted to the heat sink 350. The circuit board 352 may include one or more devices, memories and subsystem components as described further below with respect to FIGS. 4 and 5. Similar to FIG. 3D, and as illustrated in FIG. 3H, the angle theta (Θ) between the ground, as represented by reference line 338′, and a line 340′, 342′ normal to the plane of each LED 330, 332, is in the range of 20 to 35 degrees. In one embodiment, the pair of LEDs are directed or positioned with angles Θ of approximately 30 degrees. In other words, the LEDs are not mounted flush with or in the same plane as the bottom of the support structure so that light is not emitted directly downwards when the lighting device and apparatus are installed. Instead, the LEDs 330, 332 may be mounted at angles of between 55 to 70 degrees relative to a bottom edge or a bottom surface of the support structure in order to control the angle of incidence of light on the barrier and/or on the ground or surface adjacent the barrier and create an elliptical pattern. As set out above, in embodiments where the LEDs are mounted symmetrically to the support structure, the lines normal to the plane of each LED may intersect each other at an angle between 20 to 50 degrees.

Each barrier protection apparatus 110 may be spaced apart along the barrier at a predetermined distance from an adjacent barrier protection apparatus 110, which locations may or may not coincide, for example, with the post of a fence. In example embodiments, a barrier protection apparatus 110 is located every 3 to 7 metres along the barrier 105. Each barrier protection apparatus 110 also may be positioned with the lighting device 304, 314, 318 situated above the top of the barrier. Each lighting device 304, 314, 318 may be mounted at substantially the same height above the ground, or at slightly different heights, depending on the terrain or environment. In example embodiments, each lighting device 304, 314, 318 is positioned at a height of about 2.7 to 3.7 metres above the ground, or the surface at the base of the barrier 105, or at a height approximately 0.4 metres from the top of the barrier. The spacing and height of each barrier protection apparatus 110 is configured to provide the most uniform illumination. In some embodiments, the height of each lighting device 304, 314, 318 is configured to provide at least a minimum level of illumination at the average height of the head of a possible intruder standing adjacent the barrier.

As illustrated FIGS. 1A and 1B, the barrier protection apparatuses 110a, 110b, 110c in the system 100 are placed along the barrier 105 such that each of the illuminated areas 116 overlaps with that of an adjacent area 116. As noted above, the beam angles of the LEDs, flux (intensity) of the LEDs, angle of incidence, the spacing between the LEDs within each lighting device 304, 314, 318 along with the height of the lighting devices above the barrier, and the distances between each apparatus 110, may be configured to achieve the desired illumination area 116 for the particular type of barrier and target area to be illuminated. The illumination areas 116a, 116b, 116c are configured to overlap so that gradient brightness levels out between each apparatus 110a, 110b, 110c. In one example, with two barrier protection apparatuses spaced approximately 7 metres apart and the lighting device of each apparatus located approximately 2.74 metres above the base of the barrier with an LED output power of 2W, a total area of illumination 116 approximately 10 metres long and 2.4 metres wide may be provided on the ground or surface adjacent the barrier. The intensity of the light varies between 0.49 to 5.5 lux within this area 116 which enables at least a visual detection and image capture of the possible intrusion.

As described above, each barrier protection apparatus 110 includes a number of components along with one or more sensors to gather data regarding a possible intrusion, and to communicate with other barrier protection apparatuses 110 and a monitoring station or central controller 114. FIG. 4 shows a block diagram of the system 100 and a barrier protection apparatus 110 according to one embodiment. The apparatus 110 includes a processing device 402, a wireless communication subsystem 406, a sensor subsystem 410, a memory 414, a power subsystem 420 and a lighting subsystem 424, including the lighting device 304, 314.

Typically, the components of the apparatus 110 are located within the housing, such as on circuit board 352, to provide a single apparatus for deployment at positions along the barrier. The single apparatus may be supplied with power and configured to withstand the conditions of the environment. The various components of the apparatus 110 may be provided on one or more chips, printed circuits boards, or modules within the housing, including modules at different locations within the housing. In other embodiments, it will be appreciated that separate housings may be provided and the apparatus may consist of a number of discrete components or apparatuses, configured as described herein and linked by communication and/or power connections.

The processing device 402 may be a processor, a microprocessor, an application-specific integrated circuit (ASIC), a field-programmable gate array (FPGA), a dedicated logic circuitry, or combinations thereof. The memory 414 may include a volatile or non-volatile memory (e.g., a flash memory, a random access memory (RAM), and/or a read-only memory (ROM)). The memory 414 may consist of a transitory computer readable media such as a RAM, a ROM, an erasable programmable ROM (EPROM), an electrically erasable programmable ROM (EEPROM), a flash memory, or a portable memory storage. The memory 414 may store instructions for execution by the processing device 402, such as to carry out the present disclosure. The memory 414 may include other software instructions, such as for implementing an operating system and other applications/functions.

The power subsystem 420 may include a number of different configurations for providing power to the apparatus 110. In one embodiment, the power subsystem 420 is connected to a common low voltage distribution bus which may be wired along the barrier to multiple barrier protection apparatuses 110. In one embodiment, the power subsystem 420 convert a 60V AC input to a 12 DC output for use by the apparatus 110. In other embodiments, the power subsystem 420 may include a battery or other stand alone power source.

The apparatus 110 is configured to send, and receive data, including various sensor data, which is indicative of a possible intrusion or disturbance at the barrier. In some embodiments, the processing device 402 is configured to analyze data in order to determine whether a possible intrusion has occurred, such as, but not limited to an intrusion adjacent the apparatus 110. The possible intrusion may be reported to other apparatuses 110 and/or to the central controller 114. In other embodiments, the apparatus 110 is configured to receive sensor data and transmit reports of the sensor data to other apparatuses 110 and/or to the central controller 114. In some embodiments, reports of sensor data are transmitted by the apparatus 110 only in response to the sensor data meeting predetermined trigger conditions. As described further below, in response to the data received from one or more sensors, the operation of the lighting subsystem and lighting devices also may be controlled, either by the apparatus or in response to commands received from the central controller.

Sensor data may include data received from the sensor subsystem 410. In one embodiment, the sensor subsystem 410 includes a three-axis accelerometer which is mechanically coupled to the barrier and configured to detect vibrations within the barrier. Vibrations may occur, for example, due to an intruder attempting to scale the barrier structure, as denoted by the (X) in FIG. 2. In some embodiments, the accelerometer, or the accelerometer and the sensor subsystem 410, are located adjacent the mounting of the apparatus to the barrier, such as within the base of the housing of the apparatus, in order for the accelerometer to be tightly coupled to the barrier. A secure or tight coupling is provided to improve the ability of the sensor subsystem 410 to detect vibrations in the barrier without being triggered by wind or other forces of nature. In other embodiments, the sensor subsystem 410 may be configured to provide microwave-doppler sensing or passive infrared sensing. The apparatus 110 and sensor subsystem 410 may include video motion detection through the use, for example, of low cost camera modules integrated into the apparatus 110. Data or images captured by the camera modules could be used as sensor data for alarm assessment purposes. Alternatively or additionally, data or captured images could be transmitted to the central controller 114 and used for post event forensics. In some embodiments, the image capture could be triggered by the central controller 114, the processing device 402 and/or the sensor subsystem 410.

The wireless communication subsystem 406 includes transmitter and receiver components (not shown) which are coupled to an antenna 430. It will be appreciated that the functions of the wireless communication subsystem 406 may be carried out by various transceivers or modem components including multiple transmitter, receiver and antenna components or arrays. The wireless communication subsystem 406 may be configured for wireless communications in accordance with various standards or protocols. In one embodiment, the wireless communication subsystem 406 is configured to support a 2.4 GHz mesh network consisting of multiple apparatuses 110 and the controller 114 operating as a head end or gateway.

The wireless communication subsystem 406 is configured to transmit wireless signals for receipt by the wireless communication subsystem of one or more barrier protection apparatuses 110. The wireless signals transmitted from barrier protection apparatus 110b in FIG. 2A, for example, may be received by adjacent apparatuses 110a and 110c. It will be appreciated that an adjacent apparatus may include any apparatus 110 within a wireless communication range of a transmitting apparatus 110. The adjacent apparatus is not limited to an apparatus immediately adjacent the transmitting apparatus, an apparatus located on the same portion of the barrier, or an apparatus located on the same barrier as the transmitting apparatus. The wireless signals may be transmitted periodically in order to maintain communications between the apparatuses 110. Power levels and other parameters of the transmitted signals may be adjusted periodically through these exchanges of signals in order to accommodate changes in the wireless channel such as changes in the weather conditions.

The wireless communication subsystem 406 also is configured to measure various parameters or characteristics of the signals it receives from other apparatuses 110. The apparatuses 110 located on the barrier are not mobile and thus the received signals are not blocked or affected by different landscapes or structures buildings typically encountered as a wireless mobile device is moved. As a result, changes in the characteristics of the received signals may be indicative of a change in the signal path due to a possible intrusion at the barrier. The wireless communication subsystem 406 thus acts as a sensor to obtain information indicative of possible intrusions or changes in the environment.

In one embodiment, the wireless communication subsystem 310 of apparatus 110b in FIG. 2 may continuously or periodically measure a Received Signal Strength Indicator (RSSI) for each wireless signal received from the wireless communication subsystems of one or more adjacent barrier protection apparatuses 110a, 110c. If the RSSI changes, such changes may be attributed to a disruption in the signal transmission path caused by an intruder, escapee or other alarm event near the barrier as denoted by the (X) in FIG. 2. In one embodiment, the apparatus 110b may communicate an alarm condition of a possible intrusion to the controller 114 in response to the change in RSSI. The apparatus 110b may communicate an alarm condition of a possible intrusion to the controller 114 in response to the change in RSSI and a change in data from other sensors in the apparatus 110b. In other embodiments, the apparatus 110b may signal an alarm condition only in response to a change in the RSSI and receipt of a message or alarm condition from the adjacent apparatus 110a that a change in the RSSI also was noted by that adjacent apparatus 110a with respect to signals it received from apparatus 110b. In other embodiments, both apparatuses 110a, 110b may report a change in RSSI to the central controller 114. Based on the received reports, the central controller may signal the occurrence of the alarm condition and possible intrusion in the barrier adjacent apparatuses 110a and 110b. In further embodiments, each apparatus 110 transmits regular reports of the signals it receives to the central controller. The central controller is configured to monitor and analyze the received data, such as RSSI measurements from a plurality of barrier protection apparatuses 110, to determine whether an alarm condition and possible intrusion in the barrier has occurred.

In a further embodiment, data collected from multiple sensors may be combined by the apparatuses 110 and/or by the central controller 114 to determine whether a possible intrusion has occurred. For example, this multi-sensor approach provides a means to monitor vibration generated by an intruder scaling the barrier and a change in the radio frequency (RF) field caused by an intruder crossing over the top of the barrier. The change in the RF field may be detected, as described above, by a change in the RSSI value. In the case of gross intrusions or attacks, such as breaking through the barrier, data from one sensor or system alone, such as vibrations measured by the accelerometer, may be sufficient to detect the intrusion.

FIG. 5 illustrates a block diagram of a central controller 114 according to one embodiment of the present invention. The controller 114 includes a processing device 502, a wireless communication subsystem 506, a memory 514, and a power subsystem 520. The processing device 502 may be a processor, a microprocessor, an application-specific integrated circuit (ASIC), a field-programmable gate array (FPGA), a dedicated logic circuitry, or combinations thereof. The memory 514 may include a volatile or non-volatile memory (e.g., a flash memory, a random access memory (RAM), and/or a read-only memory (ROM)). The memory 514 may consist of a transitory computer readable media such as a RAM, a ROM, an erasable programmable ROM (EPROM), an electrically erasable programmable ROM (EEPROM), a flash memory, or a portable memory storage. The memory 514 may store instructions for execution by the processing device 502, such as to carry out the present disclosure. The memory 514 may include other software instructions, such as for implementing an operating system and other applications/functions.

The power subsystem 520 may include a number of different configurations for providing power to the controller 114. In one embodiment, the power subsystem 520 is connected to the common low voltage distribution bus which is wired along the barrier, as described. In other embodiments, the power subsystem 520 may include a battery or other stand alone power source or a wired power connection, such as where the controller 114 is located in a monitoring or control room or other facility.

The controller 114 includes a wireless communications subsystem 506, similar to the wireless communications subsystem 406 as described above for the apparatus 110. The controller exchanges wireless communications with the apparatuses 110 as part of the 2.4 GHz mesh network. In some embodiments, the controller includes an additional communications subsystem 532 which supports additional wired and/or wireless communications. For example, the controller may be configured to generate reports of alarms, status or other conditions which are transmitted to recipients over an internal network or an external network such as the Internet.

As described above, the central controller is configured to receive reports of sensor data and/or alarm conditions from the barrier protection apparatuses. The central controller also is configured to analyze the received data, determine whether alarm conditions have occurred and generate reports or alerts. The central controller also may be configured to transmit data to the apparatuses including instructions to control the lighting devices within each apparatus.

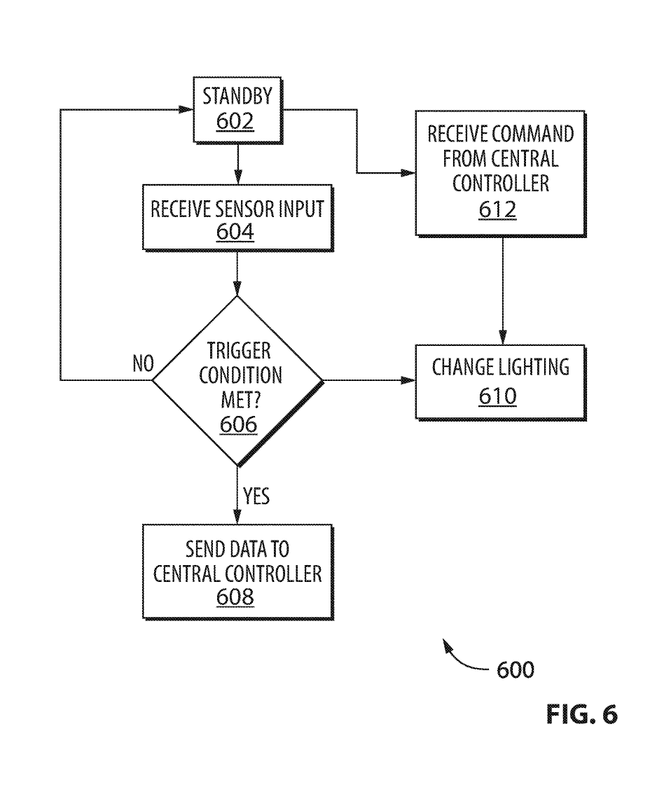

FIG. 6 illustrates a flow chart of a method of operation of the barrier protection system 100 and the interaction between the central controller 114 and one or more apparatuses 110. In a standby state 602, the lighting devices 304, 314 of the barrier protection apparatuses 110 in the system may be off or in a low-power state. In one embodiment, the lighting devices 304, 314 may be on but providing only a low level of illumination. The apparatus periodically receives input or data from one or more sensors (action 604) and determines (action 606) whether a trigger condition has been met. If the trigger condition is not met, the apparatus continues to operate in the standby state and receive sensor data. If a trigger condition is met, in one embodiment the sensor data, or a report of the trigger condition, is sent to the central controller (action 608). Alternatively or additionally, in response to the trigger condition being met, the apparatus 110 may operate to change the lighting devices (action 610), such as to turn the lighting device on or increase the level of illumination provided by the device. Thus, multiple levels of illumination may be provided.

The central controller monitors the reports of sensor data and/or alarm or trigger conditions received from each individual barrier protection apparatus. If the central controller determines that the changes in data received from at least one of the barrier protection apparatus have met a predetermined alarm condition, commands may be sent to one or more apparatuses to control the lighting device. A command may be received by the apparatus from the central controller (action 612) to change the operation of the lighting device due to an alarm detected by that apparatus or a nearby apparatus. For example, in the illustrated embodiment of FIG. 2, the apparatuses 110a and 110c may receive a command from the central controller to turn on the lighting devices in response to the central controller receiving an alarm or sensor data from the nearby apparatus 110b. After the lighting device of a barrier protection apparatus is activated, the lighting device may remain on or at a higher power level for a predetermined period of time, or until an additional command is received, such as a command to deactivate the lighting device after the alarm condition has disappeared. Thus, each apparatus may be controlled individually to add or increase lighting in an area of a possible intrusion, which may deter the intrusion or aid in the image capture of a possible intruder.

Although the present disclosure describes methods and processes with steps in a certain order, one or more steps of the methods and processes may be omitted or altered as appropriate. One or more steps may take place in an order other than that in which they are described, as appropriate.

While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A barrier protection apparatus comprising,
a processor,
a communications subsystem, and
a lighting device having,
a support structure, and
two light emitting diodes (LEDs) mounted to the support structure, the LEDs being configured to provide an elliptical pattern of light to illuminate an area around or near a barrier.

2. The barrier protection apparatus according to claim 1 wherein each LED is positioned at an angle to minimize a gradient of lighting intensity in an area below the lighting device.

3. The barrier protection apparatus according to claim 2 wherein lines normal to the plane of each LED intersect each other at an angle between 20 to 50 degrees.

4. The barrier protection apparatus according to claim 3 wherein the angle is 30 degrees.

5. The barrier protection apparatus according to claim 1 wherein the support structure comprises a heat sink.

6. The barrier protection apparatus according to claim 1 wherein the apparatus further comprises a housing containing the processor, the communications subsystem, and the lighting device, and wherein the housing is configured to be mounted to the barrier.

7. The barrier protection apparatus according to claim 1 wherein the communications subsystem comprises a wireless communications subsystem.

8. The barrier protection apparatus according to claim 7 where in the wireless communications subsystem is configured to operate as a sensor to detect a possible intrusion of the barrier.

9. The barrier protection apparatus according to claim 8 wherein the wireless communications subsystem is configured to measure changes in received signal strength indicator (RSSI) values indicative of a disruption in a wireless signal path.

10. The barrier protection apparatus according to claim 7 further comprising one or more sensors, and wherein the processor is configured to detect a possible intrusion to the barrier based on data provided by the one or more sensors.

11. The barrier protection apparatus according to claim 10 wherein the one or more sensors comprises an accelerometer configured to detect vibrations of the barrier.

12. The barrier protection apparatus according to claim 10 wherein the one or more sensors are configured to provide microwave-doppler sensing, passive infrared sensing, or video motion detection.

13. The barrier protection apparatus according to claim 10 wherein the processor is configured to control the lighting device in response to the detection of the possible intrusion.

14. A barrier protection system comprising:
a central controller, and
one or more barrier protection apparatuses spaced apart along a barrier, each barrier protection apparatus having,
a processor,
a communications subsystem configured to communicate with the central controller,
one or more sensors, and
a lighting device having,
a support structure, and
two or more light emitting diodes (LEDs) mounted to the support structure, the LEDs being configured to provide an elliptical pattern of light to illuminate an area around or near a barrier.

15. The barrier protection system according to claim 14 wherein the communications subsystem of each barrier protection apparatus comprises a wireless communications subsystem.

16. The barrier protection system according to claim 15 wherein each wireless communications subsystem is configured to measure changes in received signal strength indicator (RSSI) values indicative of a disruption in a wireless signal path.

17. The barrier protection system according to claim 15 wherein the central controller comprises a processor and a wireless communications subsystem, and wherein the central controller is configured to determine an alarm condition based on data received from the one or more barrier protection apparatuses.

18. The barrier protection system of claim 15 wherein the central controller is configured to send communications to control the lighting device of the one or more barrier protection apparatuses.

19. The barrier protection system of claim 15,
wherein each of the one or more barrier protection apparatuses is mounted to the barrier,
wherein the one or more sensors in each of the one or more barrier protection apparatuses comprises an accelerometer, and
wherein each accelerometer is configured to detect vibrations of the barrier.

20. The barrier protection system of claim 15 wherein the one or more sensors in each barrier protection apparatus are configured to provide microwave-doppler sensing, passive infrared sensing, or video motion detection.
